(19) United States
(12) Patent Application Publication
(10) Pub. No.: US 2009/0033121 A1
(43) Pub. Date: Feb. 5, 2009

(54) DISPOSABLE BED BAG

(76) Inventor: Curt McGorman, Temperance, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/831,687

(22) Filed: Jul. 31, 2007

(51) Int. Cl. B60R 13/01; B62D 33/00

(52) U.S. Cl. 296/39.1; 296/39.2

(57) ABSTRACT

A disposable bed bag, such as for a pick-up truck cargo bed, includes a bottom panel and a plurality of side walls that form a generally rectangular parallelepiped with an open top that fits within the cargo bed. The bed bag can be placed within the cargo bed to provide a barrier between received cargo and the cargo bed. The bed bag also includes a plurality of attachment points for securing the bed bag within the cargo bed. The bed bag can also envelope received cargo by using a drawpull that brings the side walls toward each other.

### BACKGROUND

Pick-up trucks typically include a cargo bed for hauling cargo, and people often use the cargo bed for hauling almost anything. Many pick-up truck owners install a bed liner to cover and protect the surface of the cargo bed. Such bed liners are often used for a wide range of reasons, including protecting the bed from dents and scratches; providing added functionality by creating compartments within the bed; and even to provide more traction in the bed so cargo will be less likely to slide around during transport.

There are several types of bed liners, including pre-fabricated liners and spray-on liners. Pre-fabricated bed liners are typically made from a thick, rigid plastic or fiberglass, and are specifically designed to fit a particular pick-up truck cargo bed based on the truck's make, model, style, and year of manufacture. Pre-fabricated bed liners are installed into the cargo bed by fastening the bed liner to the bed with screws or glue. Spray-on bed liners, on the other hand, consist of a liquid or foam substance that is applied by spraying the substance over the bed surface and allowing the substance to harden, forming a coating over the cargo bed surface. Spray-on bed liners permanently bond to the surface of the bed during the hardening process.

While bed liners protect the cargo bed from scratches and dents, they don't secure or protect cargo during transport. So, some pick-up truck owners will install a tonneau cover, which is generally a cap or cargo bed topper that covers the cargo bed. Tonneau covers may be either hard or soft, and are generally fixed to the truck bed. Unfortunately, tonneau covers can limit the capacity of the cargo bed, and are also fixed to the bed. While bed liners and tonneau covers both provide some added functionality for pick-up truck owners, there are some situations where having a bed liner, a tonneau cover, or both is inadequate.

Some cargos create issues for pick-up truck owners that cannot be addressed by a bed liner or a tonneau cover. For example, lightweight cargos, such as leaves, must be secured within a bed to ensure that they aren't lost during transport. Furthermore, lightweight cargos can also be difficult to manage during removal from the cargo bed. While a tonneau cover can help keep leaves from blowing away during transport, it doesn't help a pick-up truck owner remove the leaves from the cargo bed. Some cargos, like furniture, should be covered to guard against inclement weather and road grime, and such cargos should also be protected from a dirty bed liner. Unfortunately, a tonneau can only cover cargo if that cargo can fit underneath the cover. And a bed liner may help prevent such cargo from sliding during transport, but a dirty bed liner can transfer dirt onto the cargo. A bed liner can protect the cargo bed from messy cargo, but the liner doesn't alleviate the need to clean the bed. Many people haul messy cargos, such as garbage, yard waste, landscaping materials, liquids, and other such materials that can leave some residue or material behind. A cargo bed needs cleaning after hauling such cargos, regardless of whether the pick-up truck includes a protective bed liner or a tonneau cover.

While bed liners may protect the bed from scratches and dents, they don't alleviate the need to clean the bed, nor do they secure cargo, or protect cargo from wind and rain during transport. And while tonneau covers may cover cargo during transport, they don't alleviate the need to clean the bed, nor do they facilitate removing cargo from the cargo bed.

### BRIEF DESCRIPTION OF THE DRAWINGS

FIG. 1 shows one illustration of a disposable bed bag in a pick-up truck cargo bed.

FIG. 2 shows another illustration of a disposable bed bag.

FIG. 3 shows one illustration of a lug.

FIG. 4 is a close-up of area 4 from FIG. 1.

FIG. 5 is a close-up of area 5 from FIG. 2.

### DETAILED DESCRIPTION OF PREFERRED EMBODIMENTS

Disclosed are various exemplary illustrations of a disposable bed bag for a cargo bed. The disposable bed bag can provide a variety of uses. For example, the bed bag can provide an easily removable and disposable lining for the cargo bed; a cargo enclosure to secure cargo inside and outside of the cargo bed; as well as a convenient cargo management mechanism. A cargo bed can be used to haul a wide variety of cargos. The disposable bed bag provides a variety of options for dealing with cargos, particularly troublesome cargos, such as those that are lightweight, messy, or susceptible to damage or loss during transport from wind, rain, etc.

In one illustration, the disposable bed bag includes a bottom panel and a plurality of side walls that form a generally rectangular parallelepiped with an open top that fits within a cargo bed. The disposable bed bag can be placed within the cargo bed to provide a barrier between received cargo and the cargo bed. The disposable bed bag also includes a plurality of attachment points for securing the bed bag within a cargo bed. The disposable bed bag can be secured within the cargo bed by using lugs that are selectively received within stake pockets of the cargo bed. The disposable bed bag can also envelope received cargo by using a drawpull that can draw the side walls toward each other, thereby enveloping received cargo. Once enveloped, cargo can be easily removed from the cargo bed by simply removing the disposable bed bag from the cargo bed.

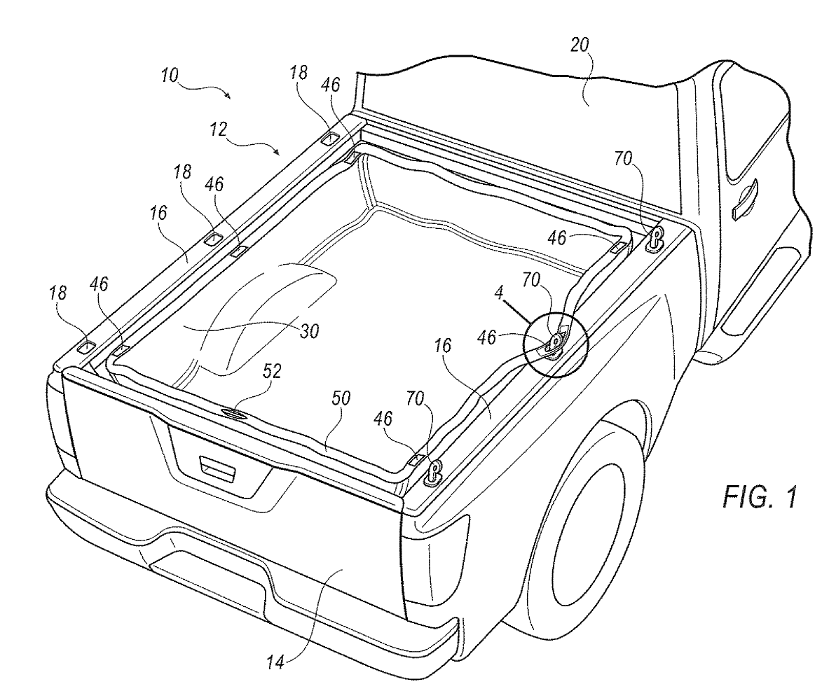

FIG. 1 illustrates a pick-up truck 10 that includes a cargo bed 12, and a disposable bed bag 30 located within cargo bed 12. Pick-up truck 10 can be any make/model of pick-up truck that includes a cargo bed 12, regardless of the particular dimensions or configuration of cargo bed 12. For example, pick-up truck 10 could be a Ranger, an F-150, or a Super Duty made by the Ford Motor Company of Dearborn, Mich.; a Canyon, a Sierra, a Sierra Classic, or a Hummer made by the General Motors Corporation of Detroit, Mich.; a Dakota or a Ram made by the DaimlerChrysler Corporation of Auburn Hills, Mich.; a Ridgeline made by the Honda Motor Corporation of Tokyo Japan, or a Tacoma or a Tundra made by the Toyota Motor Corporation of Toyota City, Japan. Furthermore, pick-up truck 10 may include optional components such as a tool box, a bed liner, a tonneau cover, or a variety of other accessories associated with cargo bed 12. Of course, disposable bed bag 30 could also be used with various trailers as well as other types of vehicles that include a cargo bed 12.

Cargo bed 12 is generally a rectangular open box used for hauling cargo, and is located between a lift gate 14, and a passenger cabin 20. Lift gate 14 typically articulates to facilitate access to cargo bed 12. The dimensions of Cargo bed 12 may vary depending on the make, model, style, and model year of pick-up truck 10. For example, the cargo bed of a 2007 GMC Sierra 1500 regular cab pick-up truck measures about 78″ by 65″ inside the cargo bed, while a 2007 Ford F-150 SuperCrew cab pick-up measures about 97″ by 65″ inside the cargo bed. Cargo bed 12 also includes two bed rails 16 that generally run along the top of cargo bed 12 between lift gate 14 and passenger cabin 20.

Bed rails 16 include a plurality of stake pockets 18. Pick-up truck 10 generally comes from the factory equipped with stake pockets 18, which are periodically located along both bed rails 16. Each stake pocket 18 is generally a recess or opening in bed rail 16 with open space extending downward toward the bottom of cargo bed 12. Stake pockets 18 can be of various shapes and sizes, but are generally rectangular openings formed in the top surface of bed rails 16. Stake pockets 18 can be used for a variety of purposes, including use with various accessories such as tie-downs, ratchet straps, bungee cords, or the like. In one embodiment, stake pockets 18 are used to help secure disposable bed bag 30 within cargo bed 12.

As shown in FIG. 1, disposable bed bag 30 is located within cargo bed 12 of pick-up truck 10. Disposable bed bag 30 can be used for a wide variety of purposes. For example, a pick-up truck owner may be transporting messy cargo like garbage, liquids, yard waste, etc. The owner may desire an easy way reduce clean-up time after hauling such cargo. An owner can place disposable bed bag 30 in cargo bed 12, as shown in FIG. 1, and then load the cargo within bed bag 30. Disposable bed bag 30 can ensure that a messy cargo doesn't come into direct contact with cargo bed 12 or an underlying bed liner. Furthermore, after removing the cargo, disposable bed bag 30 can simply be removed and discarded, leaving cargo bed 12 free from cargo remnants and greatly reducing clean-up time.

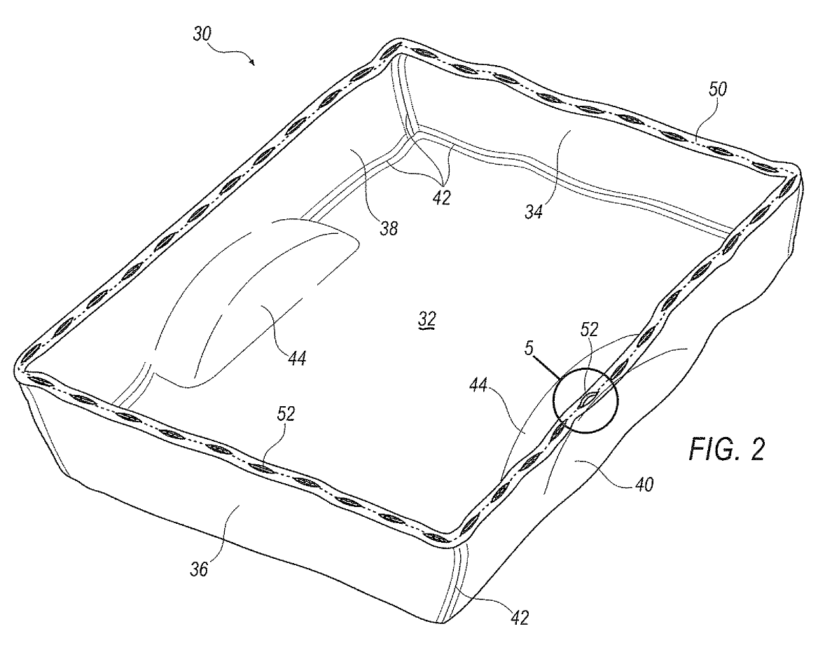

Disposable bed bag 30, as shown in FIG. 2, includes a bottom panel 32, and four side walls: front and rear side walls 34, 36; and two lateral side walls 38, 40. Bottom panel 32 and side walls 34, 36, 38, 40 are interconnected to form a generally rectangular parallelepiped with an open top. Each panel may be a separate, individual piece of material that is joined along a seam 42, as shown in FIG. 2. Of course, bottom panel 32 and side walls 34, 36, 38, 40 may also be made from one continuous piece of material that is shaped or formed into an open box structure. One skilled in the art will recognize that disposable bed bag 30 can be made using any number of different configurations, and is not limited to a specific number of individual pieces of material that can be joined together.

Bottom panel 32 and side walls 34, 36, 38, 40 are generally made from a thin, flexible plastic to ensure that bed bag 30 can conform to the shape and dimensions of cargo bed 12. Disposable bed bag 30 can be made from any number of different materials, including various plastics, such as low density polyethylene (LDPE), linear low density polyethylene (LLDPE), high density polyethylene (HDPE), or any combination thereof. The thickness of the material may depend on the application, or desired strength of disposable bed bag 30. For example, disposable bed bag 30 may be made from material that is less than 10 mils (0.010 inches) thick. For certain applications, an even thinner material may be more desirable, therefore disposable bed bag 30 may be made from material that is less than 5 mils (0.005 inches) thick, or even less than 2 mills (0.002 inches) thick. Of course, the material used to make bottom panel 32 and side walls 34, 36, 38, 40 could be of any thickness so long as the material remains flexible.

Bottom panel 32 and side walls 34, 36, 38, 40 are generally rectangular and configured to fit within cargo bed 12. In one embodiment, disposable bed bag 30 is designed to fit a cargo bed of any size, regardless of make, model, style, or model year. For example, bottom panel 32 may measure about 98′ by 66″. In such an embodiment, disposable bed bag 30 can fit to the edges of cargo bed 12, covering the entire surface of cargo bed 12, even when cargo bed 12 is very large. In such an embodiment, disposable bed bag 30 can also fit to the edges of a smaller cargo bed 12 by folding or bunching portions of disposable bed bag 30. Of course, disposable bed bag 30 could also be designed for a particular make/model of pick-up truck 10, or groupings of different pick-up trucks. For example, disposable bed bag 30 could be designed in three groups to correspond to different sizes of pick-up truck cargo beds: one for short cargo beds, one for standard cargo beds, and one for long cargo beds. Bottom panel 32 of disposable bed bag 30 could be about 72″ by 62″ for the short cargo bed group; about 80″ by 66″ for the standard cargo bed group; and about 100″ by 66″ for the long cargo bed group. Bottom panel 32 may also include two recesses 44 to accommodate the wheel wells of cargo bed 12. Recesses 44 would thereby reduce bunching of bed bag 30, reduce the amount of material required, and also provide a more tailored fit to cargo bed 12.

Referring to FIG. 1, disposable bed bag 30 can be secured within cargo bed 12 using a plurality of openings 46 and lugs 70. Openings 46 serve as attachment points that are situated on an upper portion of side walls 34, 36, 38, 40, as shown in FIGS. 1 and 4. Openings 46 can also include a reinforcement 48 around opening 46 to reduce the possibility of ripping through one of side walls 34, 36, 38, 40. Reinforcement 48 can be additional material or stitching surrounding opening 46. Additionally, reinforcement 48 could be adhesive tape, plastic rings, etc. Of course, one skilled in the art will recognize many alternatives to openings 46 that can be used as an attachment point.

Disposable bed bag 30 also includes a drawpull 50 that can be used for several purposes, including providing a plurality of attachment points. First, drawpull 50 can be used to envelope cargo within bed bag 30 by pulling the upper portions of side walls 34, 36, 38, 40 toward each other. Drawpull 50 can also be used to secure disposable bed bag 30 within cargo bed 12. And drawpull 50 can also be used to facilitate the removal of cargo from cargo bed 12.

Drawpull 50 is typically located on and runs along an upper portion of side walls 34, 36, 38, 40. As shown in FIG. 1, drawpull 50 can be a drawstring that runs along the periphery enclosed in a tunnel along the upper portions of side walls 34, 36, 38, 40. In such an embodiment, the tunnel typically includes at least one break, allowing access to an exposed section 52 of drawpull 50, generally along rear side wall 36. Exposed section 52 allows a user to pull on drawpull 50 and thereby bring side walls 34, 36, 38, 40 toward each other. Drawpull 50 can be string, twine, ribbon, plastic ribbon, webbing, or any other material or configuration that can be used to draw side walls 34, 36, 38, 40 toward each other. As shown in FIGS. 2 and 5, drawpull 50 can also be an interwoven drawstring that runs throughout side walls 34, 36, 38, 40, thereby providing periodic exposed sections 52 along the periphery of side walls 34, 36, 38, 40. Exposed sections 52 can be located anywhere along side walls 34, 36, 38, 40, including being located to correspond to stake pockets 18. In such an embodiment, exposed sections 52 can be used as attachment points, thereby eliminating the need for openings 46 along side walls 34, 36, 38, 40. Of course, disposable bed bag 30 could include multiple types of attachment points that are situated at various locations along side walls 34, 36, 38, 40. Including multiple attachment points at various locations may ensure that disposable bed bag 30 can be secured into various types of cargo bed 12, regardless of the precise location of stake pockets 18.

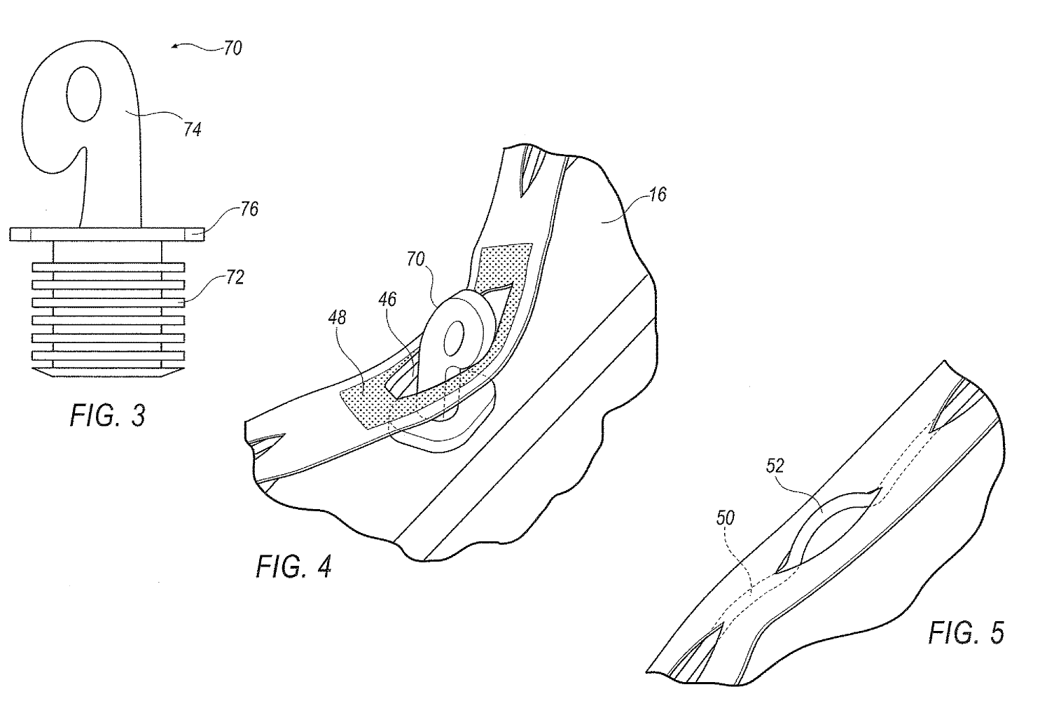

FIG. 3 illustrates a lug 70 for securing disposable bed bag 30 in cargo bed 12 by connecting to attachment points, such as openings 46. Lug 70 has an insert 72 at one end that is generally configured be secured within stake pocket 18 of bed rail 16. Insert 72 may include a firm inner core surrounded by flexible rubber rings designed to create a friction fit within stake pocket 18. Insert 72 could be shaped to accommodate stake pockets of different sizes, such as by being tapered or cone shaped. Furthermore, insert 72 could include an expansion mechanism to create a friction fit within stake pocket 18, such as by including mechanically expanding wings.

At the opposite end, lug 70 has a keeper 74 that is configured to releasably attach to an opening 46. Keeper 74, as shown in FIG. 3, is a rigid protrusion that includes an overhang to releasably secure opening 46 in place by limiting upward movement. As shown in FIG. 4, disposable bed bag 30 can be secured within cargo bed 12 by looping opening 46 over keeper 74. Of course, keeper 74 could also be an open “C” shaped, or keeper 74 could include a mechanical latch or one-way security gate to connect to an attachment point.

Lug 70 also includes a limit plate 76 that prevents lug 70 from sliding down too far into stake pocket 18. Limit plate 76 is generally wider than the opening for stake pocket 18, thereby ensuring that keeper 74 remains above the opening to stake pocket 18. A user can insert one lug 70 into each stake pocket 18 along bed rail 16, thereby providing several places to secure disposable bed bag 30 within cargo bed 12. A user can then secure disposable bed bag 30 to cargo bed 12 by connecting a corresponding attachment point to keeper 74 of lug 70, such as by looping opening 46 over keeper 74.

Disposable bed bag 30 is generally made from lightweight and flexible material, so it can be folded into a compact orientation. In a compact orientation, it can be easily stored, moved, and managed. Generally, in a compact orientation, one person can easily manage disposable bed bag 30, such as by placing disposable bed bag 30 into cargo bed 12. Placing disposable bed bag 30 into a compact orientation can also facilitate shipping and storing. The overall size of disposable bed bag 30 in the compact orientation may depend on the type of material, the thickness of that material, and the overall dimensions of bottom panel 32 and side walls 34, 36, 38, 40.

To use disposable bed bag 30, a user will first place disposable bed bag 30 into cargo bed 12. Disposable bed bag 30 may be in the compact orientation, or a user may begin unfolding disposable bed bag 30 before placing it into cargo bed 12.

Next, a user will insert one lug 70 into each stake pocket 18 along bed rail 16. Each lug 70 should fit snugly within stake pocket 70, allowing keeper 74 to remain exposed in order to connect to an attachment point. Of course, an attachment point can be opening 46, exposed section 52 of drawpull 50, or some other type of attachment point.

Next, a user places disposable bed bag 30 into a secured orientation by connecting keeper 74 of each lug 70 to a corresponding attachment point. Generally, a user will first unfold disposable bed bag 30 within cargo bed 12, and then place bed bag 30 into the secured orientation. In the secured orientation, disposable bed bag 30 will remain within cargo bed 12 while pick-up truck 10 is in motion. A user can then insert cargo within cargo bed 12, thereby placing the cargo within disposable bed bag 30.

A user can then envelop received cargo within disposable bed bag 30. For example, a user may be hauling dried leaves, which are prone to fly out of cargo bed 12 while pick-up truck 10 is in motion. To prevent the loss of such lightweight cargos, a user can envelop the cargo within disposable bed bag 30. A user will first separate attachment points 46 from lugs 70. Next, a user will pull on drawpull 50, thereby drawing side walls 34, 36, 38, 40 toward each other and placing disposable bed bag 30 into a closed position. Of course, side walls 34, 36, 38, 40 may not close all the way, but will substantially reduce the size of the opening and thereby envelope received cargo.

Disposable bed bag 30 can then be easily removed from cargo bed 12 using drawpull 50. To easily remove disposable bed bag 30 and the enveloped cargo, a user can simply open lift gate 14, and then pull on drawpull 50 to pull disposable bed bag 30 out of cargo bed 12. The enveloped cargo remains within disposable bed bag 30, and cargo bed 12 is left clean and free from cargo or cargo residue.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed devices and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

I claim:

1. A disposable bed bag, comprising:
a flexible bottom panel having an outer periphery;
at least four interconnected flexible and substantially rectangular side walls, wherein a lower section of each side wall is connected to the outer periphery of the bottom panel, forming a generally rectangular parallelepiped with an open top that is configured to fit within and generally conform to the shape a cargo bed;
a drawpull disposed along an upper portion of each side wall; and
an attachment point located on at least one of the at least four side walls.

2. The disposable bed bag of claim 1, wherein the bottom panel and the at least four side walls are made from a flexible plastic that is less than 10 mils (0.010 inches) thick.

3. The disposable bed bag of claim 1, wherein the bottom panel and the at least four side walls are made from a flexible plastic that is less than 5 mils (0.005 inches) thick.

4. The disposable bed bag of claim 1, wherein the bottom panel and the at least four side walls are made from a flexible plastic that is more than 2 mils (0.002 inches) thick.

5. The disposable bed bag of claim 1, wherein the bottom panel and the at least four side walls are designed to fit within a group of cargo beds for pick-up trucks, wherein the group is either a short cargo bed group, a standard cargo bed group, or a long cargo bed group.

6. The disposable bed bag of claim 5, wherein the bottom panel of the disposable bed bag is about 72″ by 62″ for the short cargo bed group; about 80″ by 66″ for the standard cargo bed group; or about 100″ by 66″ for the long cargo bed group.

7. The disposable bed bag of claim 1, further comprising two recesses along the bottom panel, wherein each recess is configured to accommodate a wheel well of the cargo bed, and wherein the cargo bed is for a pick-up truck.

8. The disposable bed bag of claim 1, wherein the disposable bed bag is capable of receiving cargo by moving from a compact orientation to a secured orientation in which the bed bag is unfolded to substantially conform to the shape of the cargo bed and secured to the cargo bed.

9. The disposable bed bag of claim 1, wherein the disposable bed bag is capable of enveloping a received cargo by moving from a secured orientation, where the disposable bed bag substantially conforms to the shape of the cargo bed, to a closed orientation by cinching the drawpull, which draws the upper portions of the side walls toward each other.

10. The disposable bed bag of claim 1, wherein the attachment point is an opening along the upper portion of one side wall.

11. The disposable bed bag of claim 1, further comprising a drawpull.

12. The disposable bed bag of claim 11, wherein the drawpull is a drawstring that runs through an enclosed tunnel along the upper portions of the side walls.

13. The disposable bed bag of claim 11, wherein the drawpull is a drawstring that runs along the upper portions of the side walls and includes exposed sections at select locations, wherein each exposed section is an attachment point.

14. The disposable bed bag of claim 1, further comprising a lug that includes an insert selectively received within a stake pocket of the cargo bed, and a keeper selectively releasably attached to the attachment point.

15. The disposable bed bag of claim 1, wherein the bottom panel and the at least four side walls are made from a low density polyethylene (LDPE), a linear low density polyethylene (LLDPE), a high density polyethylene (HDPE), or any combination thereof.

16. A method of hauling cargo, comprising:
installing a plurality of lugs into a plurality of stake pockets located along a bed rail of a pick-up truck cargo bed, wherein each lug includes an insert and a keeper;
placing a disposable bed bag in the pick-up truck cargo bed, wherein the disposable bed bag includes a bottom panel connected to a plurality of side walls, forming a generally rectangular parallelepiped with an open top;
unfolding the disposable bed bag, thereby moving the bed bag from a compact orientation toward a secured orientation, substantially conforming the bed bag to the shape of the cargo bed;
placing the bed bag in a secured orientation by attaching the keeper of each lug to an attachment point located along an upper portion of a side wall.

17. The method of claim 16, further comprising placing cargo within the disposable bed bag.

18. The method of claim 16, further comprising moving the disposable bed bag from the secured orientation to a closed orientation by:
detaching the keeper of the lugs from the attachment points; and
cinching a drawpull, thereby causing the side walls to move toward each other.

19. The method of claim 16, further comprising enveloping cargo within the disposable bed bag by moving the disposable bed bag from the secured orientation to a closed orientation by operating a drawpull.

20. The method of claim 16, wherein the attachment points are exposed sections of a drawpull, and placing the disposable bed bag in a secured orientation includes releasably attaching the keepers of the lugs to a corresponding exposed section of the drawpull.

21. The method of claim 16, wherein the attachment points are openings located along the upper portions of the side walls, and placing the disposable bed bag in a secured orientation includes releasably attaching the keepers of the lugs to a corresponding opening.

22. The method of claim 16, further comprising enveloping and removing received cargo from the cargo bed by:
separating the attachment points from the keepers of the lugs;
cinching a drawpull disposed along an upper portion of each of the side walls, thereby moving the bed bag toward a closed orientation and enveloping received cargo within the disposable bed bag;
opening a lift gate of the cargo bed; and
removing the enclosed cargo by pulling the drawpull and thereby pulling the disposable bed bag out of the pick-up truck bed through the open lift gate.

23. A pick-up truck, comprising:
a cargo bed with a bed rail that includes a plurality of stake pockets;
a plurality of lugs, wherein each lug includes a keeper and an insert; and
a disposable bed bag configured to fit within the cargo bed, wherein the disposable bed bag includes a bottom panel and side walls that form a generally rectangular parallelepiped having an open top, and wherein the side walls include a plurality of attachment points and a drawpull disposed along upper portions of the side walls, and wherein the disposable bed bag can be secured to the cargo bed by releasably attaching a sub-set of attachment points to the lug keepers.

24. The pick-up truck of claim 23, wherein the drawpull is interwoven along the periphery of the side walls, and the attachment points are exposed sections of the interwoven drawpull.

25. The pick-up truck of claim 23, wherein the attachment points are reinforced openings along the upper portions of the side walls of the disposable bed bag.
